(19) United States
(12) Patent Application Publication
(10) Pub. No.: US 2024/0292066 A1
(43) Pub. Date: Aug. 29, 2024

(54) METHOD AND APPARATUS FOR TRANSMITTING MEDIA FILES FROM AT LEAST ONE CENTRAL SERVER APPARATUS TO A PLURALITY OF RECEIVING DEVICES VIA A DIGITAL NETWORK

(71) Applicant: Thomas JÖRG, Zurich (CH)

(72) Inventor: Thomas JÖRG, Zurich (CH)

(21) Appl. No.: 18/573,825

(22) PCT Filed: Jun. 30, 2022
(86) PCT No.: PCT/CH2022/050014

§ 371 Date: Dec. 22, 2023

(30) Foreign Application Priority Data
Jul. 3, 2021 (CH) CH070015/2021

(51) Int. Cl. H04N 21/6547; H04N 21/218; H04N 21/24; H04N 21/433; H04N 21/435

(52) U.S. Cl. CPC H04N 21/6547; H04N 21/218; H04N 21/24; H04N 21/433; H04N 21/435

(57) ABSTRACT

The invention relates to methods for transmitting media files from at least one central server device (4) to a plurality of receiving devices (2) via a digital network (6), in which
the plurality of receiving devices (2) each have a storage means (13) for storing media files,
at least one central control instance device (3) is provided, which has a storage means (33) for storing metadata of the media files to be transmitted,
the receiving devices (2) download the metadata of the media files from the central control instance device (3) at least before the transmission of media files,
and, based on the metadata, initiate a transmission of the media files to be transmitted from at least one of the central server devices (4) and/or from at least one other of the receiving devices (2),
and in which the receiving devices (2) send status information to the central control instance device (3) in the course of transmitting the media files, which status information is used by the central control instance device (3) to update the metadata stored in the storage means (33) of the central control instance device (3).

### FIELD OF THE INVENTION

The invention relates to a method for transmitting media files from at least one central server device to a plurality of receiving devices via a digital network. The invention further relates to a suitable receiving device, a suitable central control device, a suitable central server device and a suitable media file transmission network for carrying out the method. In particular, the invention relates to a method and a device for distributing motion pictures via a digital network.

### TECHNICAL BACKGROUND

When media files were distributed from a central distribution point to a number of recipients, such as in the case of cinema films from a distributor to different cinema locations, the corresponding media files were traditionally sent by courier in physical form. In the case of cinema films, these were classic film copies that were transported on correspondingly large film reels. In view of the size and weight of the film copies, the distances to be covered and the time pressure, the logistics behind this were quite demanding, especially if there were also adverse weather conditions.

The first improvement came with the digitization of cinemas, which made it possible to store the relevant files on hard drives with significantly less space and weight and to transport them between locations. However, the deadline pressure and the distances to be bridged remained unaffected.

In the meantime, the expansion of the bandwidths of generally available data networks (such as the Internet) and, in particular, the widespread availability of fast end connections (the so-called “last mile”) have made it possible to distribute data non-physically in digital form via networks. In particular, this type of media transmission has also become increasingly interesting from an economic perspective over the years.

However, due to the encoding of the image data to be transmitted in the cinema sector (usually in the form of so-called DCPs=digital cinema packages) with typical file sizes in the range of 100 GB to 500 GB, even today's networks are still reaching their limits. Even with fast end connections, transfer times of media files in the range of several hours to half a day are not uncommon.

A further problem arises on the transmitter side, as correspondingly powerful server locations with correspondingly large transmission capacities must be provided in order to make the data streams available on the transmitter side. In the case of several hundred receiver locations (cinema locations), this is still a cost-intensive undertaking even today. Another problem is the system's reliability. If a central server location fails (even if only temporarily), the entire distribution system is called into question. If you want to create redundancy by using several server locations, the costs on the provider side multiply accordingly.

It is therefore the task of the present invention to propose a method for transmitting media files from at least one central server device to a plurality of receiving devices, which is improved over previous methods. A further task of the invention is to propose devices for distributing or receiving media files, which are improved over previous devices known in the prior art.

### DESCRIPTION OF THE INVENTION

These and other tasks of the invention are solved by the proposed method, the proposed receiving device, the proposed central control device, the proposed central server device and the proposed media file transfer network.

A method for transmitting media files from at least one central server device to a plurality of receiving devices via a digital network is proposed. This plurality of receiving devices each has a storage means for storing media files. Furthermore, at least one central control instance device is provided, which has a storage means for storing metadata of the media files to be transmitted. The receiving devices download the metadata of the media files from the central control instance device at least before the media files are transmitted. Based on the metadata, the receiving devices initiate a transmission of the media files to be transmitted from at least one of the central server devices and/or from at least one other of the receiving devices. In the course of the transmission of the media files, the receiving devices send status information to the central control instance device, which is used by the central control instance device to update the metadata stored in the storage means of the central control instance device. The central server device may in particular be a typical computer center or data center in which a large number of computers are coupled together to form a network. Such data centers can be found in many countries around the world with different levels of security. They are used for a variety of tasks, some dedicated to specific tasks, others for universal tasks. The receiving devices can be electronic computers in particular, especially those that are assembled from typical, commercially available computer components. However, classic peripheral devices can usually be dispensed with (such as printer connections, keyboard connections, graphics cards/graphics card connections and the like). Standard operating systems can be used, such as Windows-based operating systems or Unix-based operating systems (e.g. Linux). SSDs (solid state disks) or classic hard disks, also in combination, can be used as storage media for essentially permanent data storage (to be distinguished from RAM (random access memory)). In view of the data sizes for digital media files (especially so-called DCPs=digital cinema packages), which are typically between 100 GB and 500 GB in the professional sector, the storage media must be dimensioned accordingly. It makes sense to provide at least 6-8 TB of storage. To increase the reliability of the system, the devices used (receivers, central server device, central control device) can be supplied with energy by means of an uninterruptible power supply. While typical computer centers can usually be supplied with power by generators on a largely permanent basis anyway (in the event of a power grid failure), it often proves to be sufficient, particularly for the receiving devices, if only certain periods of time can be bridged without interruption (for example 10 minutes; the period of time to be selected depends on the reliability of the power grid). In principle, the digital network can be a private network, a public network or a so-called VPN (virtual private network). The protocols used-such as TCP/IP (Transmission Control Protocol/Internet Protocol) or similar-can also be chosen at will. The at least one central control instance device can-but does not have to-coincide with the at least one central server device. A separate design can offer particular advantages in terms of manageability. The media files to be transmitted are generally provided in full (initially) at least on the at least one central server device, so that the at least one central server device can form a starting point for further distribution. The initial provision of the media files on the at least one central server device can take place physically (for example by connecting hard disks, loading storage tapes, optical and magneto-optical storage means), but can also take place via a network. It should be noted that this “initial transmission” is usually only required once, possibly only once per central server location, and therefore the data volumes to be transmitted are comparatively manageable. In addition, these are usually entities that already have access to data lines with very broadband transmission rates (fiber optic connection and the like), so that fast initial data transmission to the at least one central server device is also given due to the data transmission rates available for these entities. Accordingly, at the very first request of the first receiving device to download a specific, newly set media file, this receiving device is only able to receive the corresponding media file from the at least one central server device. However, as soon as the media files are also available on at least one other of the receiving devices, the corresponding media file can additionally or alternatively also be received by the at least one other receiving device. Over time, the number of receiving devices available for this purpose will increase accordingly. In particular, it is also possible to receive data from a plurality of receiving devices/central server devices simultaneously. Furthermore, it is also possible that (essentially) exclusive downloading from other receiving devices is possible, particularly in the case of popular films. Of course, it is also conceivable that an “initial setting” of a media file is not or not only carried out on a central server device, but also/essentially exclusively/only on one or more receiving devices (especially if no time-critical media files to be distributed are involved). It should be noted that the media files in question can be sent not only as a whole and as an uninterrupted data stream from one receiving device/central server device to another, but that they can also be sent as a large number of data packets (in particular the position of the data packet in question within the overall file) that may be largely independent of one another. This is the case anyway with a larger number of possible data transmission protocols. It is therefore possible that when a media file is received, different data packets (and therefore also different parts of the media file) are received from a number of output points (central server devices and/or other receiving devices), which are assembled into the actual media file in the receiving device using basically known algorithms. A major advantage here is that the central server devices can be relieved to a considerable extent, which can have a correspondingly cost-reducing effect. In addition, the reliability of the overall process or the overall system can also be increased because, for example, the failure of the central server device (or the central server devices, or parts thereof) can be compensated for at least over a certain period of time by the network of different receiving devices (if one disregards extremely unfavorable times of failure of the central server device/the central server devices). Furthermore, in the proposed method, the receiving devices send status information to the central control instance device in the course of transmitting the media files, this status information being used by the central control instance device to update the metadata stored in the storage means of the central control instance device. Since the status information in question comprises only comparatively small amounts of data, the amounts of data in question are largely negligible in relation to the data stream of the actual media files. Accordingly, such status information can easily be transmitted in small time periods, such as for example every second or at intervals of a few seconds (for example 5 seconds, 10 seconds, 20 seconds, 30 seconds), or even at intervals of minutes or a few minutes, without this being of major relevance for the network. It should be noted that although the updated metadata is generally beneficial for increasing the efficiency of the transmission of media data (especially in the case of a new initiation of a media file transmission), it often has only a comparatively small effect on the transmission of the media files (especially in the case of media file transmissions that have already started), but at least an interruption of the transmission can often be avoided, at least if there are no excessively long downtimes.

It is further proposed that in the proposed method, the metadata comprises information taken from the following group:
Information about which of the media files are to be transmitted to which receiver or receivers;
Information regarding the transfer priority of the media files to be transferred;
Information regarding a transfer progress of a media file in transfer and/or a transfer speed of a media file in transfer and/or an estimated remaining transfer time for the transfer of a media file in transfer;
information regarding a queue position of a media file to be transferred and/or;
Information regarding the receiving devices that participate in the procedure for the transmission of media files and/or are authorized to do so;
information relating to the receiving devices which have stored at least parts of the media files to be transmitted in their storage means, and in particular information about which parts of the media files to be transmitted are stored in the storage means of the respective receiving devices;
Information regarding the completion of the transfer of a media file;
Information about which media files are to be deleted from which receivers.

One type of information, any sub-selection of the aforementioned types of information, or all of the aforementioned types of information can be used. It should also be noted that the above list is not necessarily exhaustive. The provision of such a central control instance device is particularly advantageous for the requirements of the distribution of media files for cinemas. For example, by providing information on which receiving devices are authorized to participate in the process of transmitting media files or are currently doing so, security against attacks can be increased on the one hand, and protocol overhead can be reduced and/or data throughput increased on the other, since receiving devices do not first have to “blindly” query all other receiving devices to find out where the corresponding data is available, but can immediately determine a suitable download strategy based on the centrally available information. Using the central control instance device, and in particular based on the information about which media files are to be transmitted to which receiver device, as well as based on the transmission priority of the media files to be transmitted (which can of course vary from receiver device to receiver device), it is also possible, for example, for the distributor to initially restrict distribution to those receiver devices or to prioritize distribution to those receiver devices where a film start is more or less imminent or—in extreme cases—a live transmission is planned. At the same time, it is possible to use any available free line capacities (idle capacities) by assigning a correspondingly low priority, for example to transmit a film to a cinema where the film release is not scheduled for several weeks. It is also conceivable that, in the latter case in particular, the transmission of media files is at least initially limited to the fact that the files in question are obtained exclusively from other receiving devices (even if this slows down the downloading of the media files in question). Only when the performance date approaches can any missing parts of the media files be downloaded from the at least one central server device. In this way, the data traffic with the central server device can be further reduced particularly effectively. In the case of cinemas where a film release is not planned at all, on the other hand, transmission of the film can be prevented. The information about which media files or what proportion of which media files is already available on which receiving device makes it possible in a particularly advantageous way for the client, recipient and possibly also other interested parties to gain a good overview of the current transmission situation, whereby it is also not necessary for the parties concerned to be on site, i.e. to have physical access to the receiving device in question. It should be noted that it is of course also possible that (parts of) the metadata can be obtained from other receiving devices, especially if there is a (temporary) failure of the central control device(s).

It is further proposed that the at least one central control instance device can be controlled remotely via the digital network by means of smartphones, tablet computers, computers or portable computers and/or that the metadata located in the storage means of the control instance device can be read out remotely via the digital network by means of smartphones, tablet computers, computers or portable computers. In this way, it is not necessary for the client, recipient, administrator, other interested parties, etc. to have physical access to the at least one control instance device, the receiving devices and/or the at least one central server device. Since only small amounts of data are required to control the control instance device or to read out information of interest from the control instance device, not only any stationary PC equipped with appropriate software can be used for this purpose. Rather, it is also possible to control or read out data with the aid of a suitable app using a mobile tablet computer or smartphone, including via a mobile network.

Furthermore, it may be provided that in the proposed method the receiving devices repeatedly download the metadata of the media files from the central control instance device, in particular also during an ongoing transmission of media files. On the one hand, certain time intervals can be provided, such as every second, at intervals of a few seconds (e.g. 5 seconds, 10 seconds, 20 seconds, 30 seconds), or also at intervals of minutes or a few minutes (e.g. 5 minutes, 10 minutes, 20 minutes, 30 minutes). As the data volume of the metadata is extremely small compared to the data volume of the media files to be transmitted, such time intervals are generally completely unproblematic. Additionally or alternatively, it is also conceivable that a query is made based on the percentage of media files loaded, such as a query for each percentage of a media file that has been loaded. By regularly querying the media files, it is possible on the one hand for the current download strategy (download strategy) of a receiving device to be optimized. On the other hand, it is also possible for a new job to transfer specific media files to a specific receiver device to be recognized promptly and started automatically without user intervention. Of course, the latter also applies in the same way if the priority for certain media files should change. As already mentioned, it is quite conceivable that (parts of) the metadata can also be obtained from other receivers. It may therefore be a case of “indirect” reception of the current metadata from the control instance device. In addition, as also mentioned, a temporary failure of the control instance device(s) can be bridged by receiving (parts of) the metadata from other receiving devices.

It is further proposed that, in the method, the receiving devices prioritize the beginnings of the relevant media files during the transmission of media files, in particular for media files that are to be transmitted with priority. In this case, it is possible to start a movie even if, for example, the last remaining percent of the relevant media file has not yet been transmitted. These last remaining percentages can usually be reloaded during the screening so that the movie can ultimately be shown without interruption. In this context, it should be pointed out that it can make sense for the end of the media file in question to be loaded first, especially in the case of media files with very low or no priority. For example, if the last 10% of the media file is loaded first on the receiver of a cinema where a film is not scheduled to be released for another two weeks, this last 10% of the media file is available for transmission to another receiver where the film is already being projected or the film release is imminent. By increasing the number of data sources “for the last 10%”, the redundancy of the system can be increased. In this context, a brief reference should be made to the basic structure of so-called DCPs (digital cinema packages): these typically have an XML header (extended markup language) and an MXF header (material exchange format), which should always be transferred first. This is generally not a problem, as these headers usually only take up a few kilobytes to a few megabytes of data. These headers describe the structure of the media file with regard to the actual data (frames), which are typically in JPEG2000 format and make up the vast majority of the data volume of a media file. So when we talk about the “last 10%” of a media file, this typically means that the headers are complete and the last 10% of the JPEG2000 frames are present (whereas the first 90% of the JPEG2000 frames are missing).

In addition, it is proposed that in the method at least parts of the network are a public network, and the data transmission is preferably at least partially carried out by means of encrypted data transmission, particularly preferably via a virtual private network (VPN). In this way, it is advantageous to use existing infrastructure that is available at low cost and still achieve a high level of security. In particular, the Internet and typical “last mile” end connections such as DSL connections, ADSL connections, VDSL connections, fiber optic connections, coaxial cable connections (cable television) and the like should be considered. (DSL=digital subscriber line; ADSL=asynchronous digital subscriber line; VDSL=vectorial digital subscriber line). Data transmission rates suitable for the proposed method typically start at 16-20 Mbps. Accordingly, it is obvious that today's widespread end connections generally provide fully sufficient data transmission rates. Encrypted data transmission can be based on the HTTPS protocol (hypertext transfer protocol secure), for example, or on well-known internal encryption algorithms. Since DCP files are generally encrypted anyway, for performance reasons it is generally possible to limit the encryption to the data traffic relating to the metadata, i.e. in particular to the data streams between the receiving devices and the control instance device(s), and the relevant proportion of the data streams between the receiving devices (i.e. the proportion of the data streams relating to metadata). In this way, unnecessary over-encryption can be avoided.

In the method, it is further proposed that the at least one central control device and/or the at least one central server device is a redundant system such that, in the event of a partial failure of the respective system, the functionality of the system can be taken over by its remaining components. This is generally understood to mean a multiple design of the system, whereby if one subsystem fails, the other subsystem automatically takes over the tasks of the failed system. Such redundant systems are known and widespread in the state of the art. Such a design significantly increases the availability of the proposed method. In particular, in the case where (only) the central control device is designed redundantly, a system that is already highly failure-tolerant can be provided at a comparatively low cost.

According to a further aspect of the invention, a receiving device with a storage means for storing media files and a control logic is proposed, which is designed and set up in such a way that it can participate in a method according to the previous description. In this respect, the receiving device can have the same properties and advantages as those already described in connection with the proposed method, at least by analogy. In addition, the receiving device can be further formed in the sense of the previous description, at least by analogy, and can in this respect also have the advantages and properties already described, at least by analogy.

In particular, it is proposed that the receiving device has an interface for transferring media files in an internal network, in particular via Ethernet and/or by means of the FTP protocol (FTP=file transfer protocol). Such networks and protocols are known and widely used. Ethernet and FTP in particular are also used in many local cinema installations, so that the proposed receiver can generally be used in conjunction with existing cinema installations without any problems. This increases the ease and universality of use of the proposed receiver device. In particular, it is possible that media files stored (completely) in the storage means of the receiver device are transferred locally from the receiver device to a local storage (typically a RAID hard disk storage; RAID=redundant array of independent disks) via (Gigabit) Ethernet and/or FTP protocol, where—for example when using the receiver device in a cinema installation—the local projectors can access the corresponding media file. The file sizes under discussion in the range between 100 GB and 500 GB can easily be transferred in comparatively short periods of time via Gigabit Ethernet (even via 100 Mbit Ethernet, for example).

In addition, it is proposed that the receiving device has an interface for transmitting video signals, in particular using the HDMI standard or the DisplayPort standard (HDMI=high definition media interface). These interfaces are also already widely used in current cinema installations. Accordingly, the simple and universal applicability of the proposed receiver device is once again promoted here. For the sake of completeness, it should be noted that the proposed interfaces for the transmission of video signals are generally used for LIVE broadcasts.

The design of the receiving device with an interface for an external network and an interface for an internal network or an interface for transmitting video signals makes it possible for the local network or the local installation to be logically separate from the external network (e.g. the Internet). This can significantly increase protection against possible attacks.

Finally, it is proposed that the receiving device has an interface for connection to a local operating device, preferably assigned to the location of the receiving device, in particular for communication with the at least one central control instance device, i.e. an interface for connection to a local operating device assigned to the location of the receiving device for communication with the at least one central control instance device. This enables particularly fast and direct control and monitoring of the process or system for operating personnel on site. In particular, such an operating device mimics a conventional existing installation, so that a transition is possible for the operating personnel without significant familiarization.

In addition or alternatively, a central control instance device with a storage means for storing metadata of media files to be transmitted is proposed, which is designed and set up in such a way that it can participate in a method according to the previous description. In this respect, the central control instance device may have the same features and advantages as already described in connection with the proposed method, at least by analogy. In addition, the central control instance device can be further developed in the sense of the previous description, at least by analogy, and can likewise have the advantages and properties already described, at least by analogy, in this respect.

Furthermore, a central server device is proposed, wherein the central server device is designed and set up in such a way that it can participate in a method according to the previous description. In this respect, the central server device may have the same features and advantages as already described in connection with the proposed method, at least by analogy. In addition, the central server device can be further formed in the sense of the previous description, at least by analogy, and can in this respect also have the advantages and properties already described, at least by analogy.

Finally, a media file transmission network is proposed which is designed and set up in such a way that it performs a method according to the previous description, or which comprises at least one receiving device according to the previous description, at least one central control instance device according to the previous description, and/or at least one central server device according to the following description. In this respect, the media file transmission network may have the same features and advantages as already described in connection with the proposed method, at least by analogy. Furthermore, the media file transfer network can be further formed in the sense of the previous description, at least by analogy, and can in this respect also have the advantages and properties already described, at least by analogy.

If reference is made to a standard (e.g. Ethernet, FTP, HDMI and the like) in connection with the present description, the respective current definition at the time of the filing date or priority date of this application applies in particular.

### DESCRIPTION OF THE DRAWINGS

Further advantageous aspects of the invention are apparent from the following description of embodiments of the invention with reference to the figures, which show:

FIG. 1A schematic view of a possible example of a media file transfer network;

FIG. 2A schematic side view of a receiver;

FIG. 3 a flowchart for a possible embodiment for implementing the present method on a receiving device.

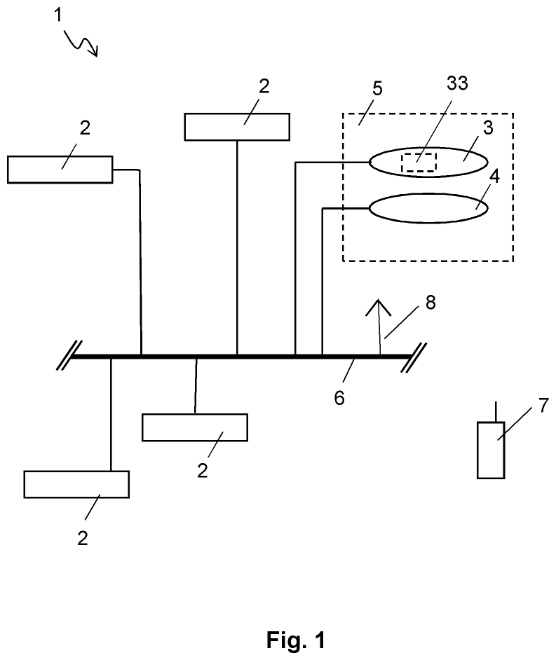

FIG. 1 shows a schematic view of a possible example of a media file transmission network 1 for transmitting media files. The media file transmission network 1 has a plurality of receiving devices 2 which, according to the present proposal, can also serve as transmitting devices if corresponding data is available, and which could accordingly also be referred to as combined transmitting/receiving devices. The receiving devices 2 have access to a public network 6, such as the Internet 6. The connection between the receiving device 2 and the Internet 6 can be either direct or indirect, for example via commercially available routers or modems. The data transmission rates are ideally more than 20 Mb/s in the download, which is why DSL connections with data transmission rates of at least 16 Mb/s, but preferably VDSL connections with data rates of 25 Mb/s, 50 Mb/s, 100 Mb/s or 250 Mb/s or the like, or, for example, fiber optic connections with data throughput rates of 500 Mb/s or 1 Gb/s in the download are preferred.

Furthermore, a control instance device 3, which has a storage means 33 for storing metadata of the media files to be transmitted, and a central server device 4, for example in the form of a data center, are connected to the Internet 6. The control instance device 3 and the central server device 4 can be designed separately from each other (for example by renting corresponding capacities in different data centers). However, it is also possible for the control instance device 3 and the central server device 4 to be implemented as a common unit 5, for example in a single data center.

For the sake of completeness, it should be pointed out that control instance device 3 and/or central server device 4 (or common unit 5) can be designed multiple times, whereby a corresponding redundancy can advantageously be realized, so that the reliability of the media transmission network 1 can be significantly increased.

As is usual with public networks, in particular also with the Internet 6, it is possible that all connected units can communicate with each other in principle, i.e. in the present case all receiving devices 2, the control instance device 3 and the central server device 4 (or possibly the control instance devices 3 and/or the central server devices 4).

Furthermore, a smartphone 7, on which a suitable app is installed, can also communicate with the Internet 6 via mobile phone access 8 (only shown schematically). As a result, the smartphone 7 (or the app loaded in the smartphone 7) has access to the control unit 3 in particular.

For the sake of completeness only, it is pointed out that, in addition to or instead of a smartphone 7, a conventional computer or a computer center of a film distributor or the like can of course also be connected to the Internet 6. In particular, a computer center of a film distributor or film producer usually has extremely broadband access to the Internet 6. The “computer center of a film distributor” will usually be the computer center of a service provider commissioned by a film distributor, such as the computer center of a film lab or the like.

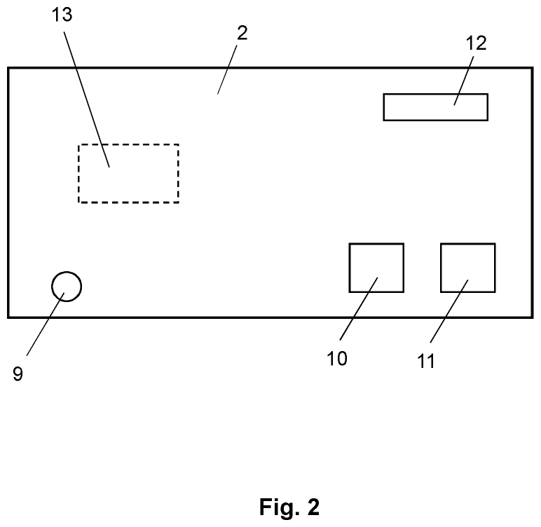

FIG. 2 shows a schematic side view of a possible embodiment of a receiver 2. The receiver 2 is designed as a compact device with a plurality of connections 9, 10, 11, 12. In addition to a power connection 9 (this can, for example, be designed as a mains connection or also as a connection for a suitable power supply unit), there are in particular the network accesses 10, 11, namely a connection for an external network (WAN=wide area network) 11, which is used, for example, for connection to a router, a modem or the like, and a connection for connection to an internal network 10 (LAN=local area network). It is quite possible that both network connections 10, 11 are based on the same network protocol and/or the same network hardware. Accordingly, it is possible that both connections 10, 11 are designed as RJ-45 plug connections for 1 Gb/s or 10 Gb/s Ethernet.

The internal network connection 10 is usually connected to a so-called switch (sometimes also referred to as a patch box). It may also make sense to provide a number of internal network connections 10.

Furthermore, an HDMI socket 12 is provided on the receiver 2. This is a widely used video connection standard, which in particular also has DRM functionality (DRM=digital rights management).

All media information, in particular streaming media files for LIVE broadcasts, as well as media files, for example in DCP format (DCP=digital cinema package), are read in from the external network 6 (e.g. Internet) via the external network connection 11. Internal forwarding, on the other hand, typically takes place depending on the respective signal, namely for LIVE signals typically via the HDMI socket 12. In contrast, DCP files are usually only downloaded as a complete media file via the internal network connection 10, for example to a local RAID drive, when they are completely available in the storage means 13 (mass storage) of the receiving device 2.

It should be noted that the receiving device 2 and its different network connections 10, 11 (or the HDMI socket 12) provide a logical separation (physical separation) between the local network (LAN) and the external network (Internet 6, WAN). This can significantly increase security against hacking attacks.

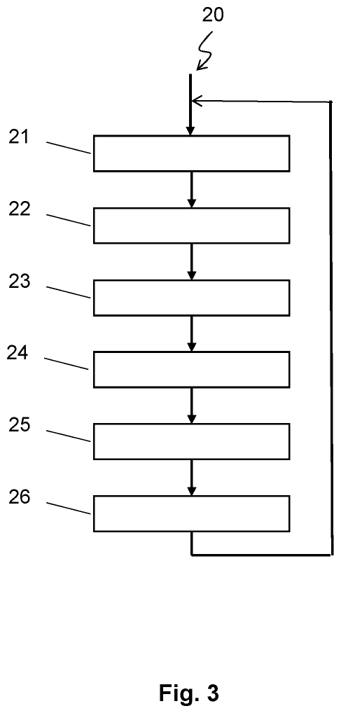

FIG. 3 shows a schematic flow diagram 20 for the transmission method proposed here. This is described here in particular from the perspective of a receiving device 2. The corresponding procedures on the other connected devices, such as in particular on the control instance device 3 and on the central server device 4, are analogous.

After the receiving device 2 is switched on—or at regular intervals, for example at intervals of 30 seconds or 1 minute-a suitable control unit of the receiving device 2 (typically a classic computer architecture consisting of processor, data bus, mass storage—for example hard disk or SSD—and, if necessary, suitable peripheral interfaces) first checks whether there is access to the Internet 6. This is done by a control logic, for example in the form of a software program. If there is access to the Internet 6, the receiving device 2 queries the metadata stored there by the control instance device 3 (step 21).

In particular, the receiving device 2 thereby receives information about which media files in the local storage means 13 (mass storage) of the receiving device 2 are to be downloaded and, if applicable, whether there is a priority (and, if applicable, which one) for the download process (download process). Based on this information, the local control unit of the receiving device 2 determines whether parts of the media files to be downloaded or even complete media files of the media files to be downloaded are already available locally (in the storage means 13 of one or more other receiving devices 2). In this way, it determines the complete media files still to be downloaded from the network 6 or the parts of media files still required (step 22).

Furthermore, the metadata contains information about where the relevant (parts of) media files can be found, i.e. on which central server device 4 (or which central server devices 4) and/or on which decentralized receiving device 2 or which decentralized receiving devices 2 the relevant data can be found. It then initiates a download process of the corresponding file packages (step 23).

In particular, the priority of the media files to be downloaded, their availability and also the position of the relevant data packets within the complete media file to be downloaded are taken into account. It usually makes sense for the beginning of a media file to be downloaded first, especially if the media file in question has a higher priority for downloading.

In the course of the download process or download processes, the receiving device 2 sends regular status information to the control instance device 3 (step 24). This status information concerns, for example, the download progress, i.e. in particular what percentage of the relevant media file has already been downloaded, but also, if applicable, which parts of the relevant media file have been downloaded. Further status information can also consist of informing the control instance device 3 that the relevant receiving device 2 is basically available, which IP address is currently assigned to the receiving device 2, and which media files (or which parts thereof) are present in the local memory (mass storage) of the receiving device 2, and which are therefore available for requests from other receiving devices 2 (step 25).

The next step 26 checks whether other receiving devices 2 are requesting data from the local receiving device 2. In response to a corresponding request, the relevant data is sent to the requesting receiving device 2 via the external network connection 11 and the Internet 6 (step 26). Whether such data is sent may depend on whether a corresponding authorization of the requesting receiving device 2 is noted in the downloaded metadata.

This sequence of work steps is repeated cyclically and, in principle, indefinitely. Of course, the steps can also be executed (partially) in parallel (multitasking), which is the rule with today's computer systems.

Due to the regular transmission of status information to the control instance device 3 (step 24), the metadata stored in the control instance device 3 is largely up-to-date. Providers, recipients and other interested parties can thus use a corresponding app to query the current download status for certain media files using a smartphone 7. It is not necessary for these to be in a specific location. Rather, the query can be made from any location and, in particular, on the move.

New orders can also be fed into the control device 3 and/or new media data can be fed into the central server device 4 in this way (possibly also via fixed computers and/or extremely broadband data lines).

By regularly querying the current metadata (step 21), the download strategy of the receiving device 2 can be adapted and optimized. This concerns not only the question of which data/media files are currently to be downloaded (this may well change as a result of newly set orders or changed priorities), but also from where they are available. Using suitable algorithms, the data traffic of the central server device 4 in particular can be significantly reduced, which can result in considerable cost benefits.

Furthermore, a certain degree of redundancy can be realized in this way. If, for example, the central server device 4 and/or the control instance device 3 fails for a certain period of time, the already started or planned download processes can be continued based on the metadata stored in the local storage means 13 of the receiving device 2. It is therefore possible to continue the download process for a period of 10 minutes or more.

Furthermore, if the metadata is too out of date, a blind request can be sent to all accessible receivers 2 based on the information about which receivers 2 belong to the media data transmission network 1 and at which IP address they can be reached, and the download process can be continued afterwards if necessary.

In this context, it should be noted that normal end connections to the Internet (and therefore most of the receiving devices 2) do not have a fixed IP address due to forced disconnection. Instead, the IP address typically changes once a day. In contrast, it is highly advantageous if the control instance device 3 and the central server device 4 have a permanent IP address. However, this is usually the case for data centers anyway.

1. Method (20) for transmitting media files from at least one central server device (4) to a plurality of receiving devices (2) via a digital network (6),
wherein the plurality of receiving devices (2) each has a storage means (13) for storing media files,
wherein at least one central control instance device (3) is provided, which has a storage means (33) for storing metadata of the media files to be transmitted,
wherein the receiving devices (2) download the metadata of the media files from the central control instance device (3) at least prior to the transmission of media files,
and, based on the metadata, initiate a transmission of the media files to be transmitted from at least one of the central server devices (4) and/or from at least one other of the receiving devices (2),
and wherein the receiving devices (2) send status information to the central control instance device (3) in the course of transmitting the media files, which status information is used by the central control instance device (3) to update the metadata stored in the storage means (33) of the central control instance device (3).

2. The method (20) according to claim 1, wherein the metadata comprises information taken from the following group:
Information about which of the media files are to be transmitted to which receiver or receivers (2);
Information regarding the transfer priority of the media files to be transferred;
Information regarding a transfer progress of a media file in transfer and/or a transfer speed of a media file in transfer and/or an estimated remaining transfer time for the transfer of a media file in transfer;
Information regarding a queue position of a media file to be transferred and/or;
Information regarding the receiving devices (2) which participate in the procedure for the transmission of media files and/or are authorized to do so;
Information relating to the receiving devices (2) which have stored at least parts of the media files to be transmitted in their storage means (13);
Information regarding the completion of the transfer of a media file;
Information about which media files are to be deleted from which receivers (2).

3. Method (20) according to claim 1, wherein the at least one central control instance device (3) can be controlled remotely via the digital network (6) by means of smartphones (7), tablet computers, computers or portable computers and/or the metadata located in the storage means (33) of the control instance device (3) can be read out remotely via the digital network (6) by means of smartphones (7), tablet computers, computers or portable computers.

4. Method (20) according to claim 1, characterized in that the receiving devices (2) repeatedly download the metadata of the media files from the central control instance device (3), in particular also during an ongoing transmission of media files.

5. Method (20) according to claim 1, characterized in that the receiving devices (2) prioritize the beginnings of the relevant media files during the transmission of media files, in particular for media files which are to be transmitted with a priority.

6. Method (20) according to claim 1, wherein at least parts of the network (6) are a public network (6), and the data transmission preferably takes place at least partially by means of encrypted data transmission, particularly preferably via a virtual private network.

7. Method (20) according to claim 1, wherein the at least one central control instance device (3) and/or the at least one central server device (4) is a redundant system, such that in the event of a partial failure of the respective system (3, 4), the functionality of the system (3, 4) can be taken over by its residual components.

8. Receiving device (2) with a storage means (13) for storing media files and a control logic, which is designed and set up in such a way that it can participate in a method For transmitting media files from at least one central server device (4) to a plurality of receiving devices (2) via a digital network (6)
wherein the plurality of receiving devices (2) each has a storage means (13) for storing media files,
wherein at least one central control instance device (3) is provided which has a storage means (33) for storing metadata of the media files to be transmitted,
wherein the receiving devices (2) download the metadata of the media files from the central control instance device (3) at least prior to the transmission of media files
and based on the metadata, initiate a transmission of the media files to be transmitted from at least one of the central server devices (4) and/or from at least one other of the receiving devices (2′),
and wherein the receiving devices (2) send status information to the central control instance device (3) in the course of transmitting the media files, which status information is used by the central control instance device (3) to update the metadata stored in the storage means (33) of the central control instance device (3).

9. Receiving device (2) according to claim 8, comprising an interface (10) for the transmission of media files in an internal network, in particular via Ethernet and/or by means of the FTP protocol.

10. Receiving device (2) according to claim 8, comprising an interface for the transmission of video signals (12), in particular using the HDMI standard or the DisplayPort standard.

11. Receiving device (2) according to claim 8, comprising an interface for connection to a local operating device, in particular for communication with the at least one central control instance device (3).

12. A central control instance device (3) comprising a storage means (33) for storing metadata of media files to be transmitted, wherein the central control instance device (3) is designed and arranged to participate in a method For transmitting media files from at least one central server device (4) to a plurality of receiving devices (2) via a digital network (6),
wherein the plurality of receiving devices (2) each has a storage means (13) for storing media files,
wherein at least one central control instance device (3) is provided, which has a storage means (33) for storing metadata of the media files to be transmitted,
wherein the receiving devices (2) download the metadata of the media files from the central control instance device (3) at least prior to the transmission of media files,
and based on the metadata, initiate a transmission of the media files to be transmitted from at least one of the central server devices (4) and/or from at least one other of the receiving devices (2),
and wherein the receiving devices (2) send status information to the central control instance device (3) in the course of transmitting the media files, which status information is used by the central control instance device (3) to update the metadata stored in the storage means (33) of the central control instance device (3).

13. Central server device (3), which is designed and set up in such a way that it can participate in a method according to claim 1.

14. (canceled)
